(19) United States
(12) Patent Application Publication
(10) Pub. No.: US 2024/0013606 A1
(43) Pub. Date: Jan. 11, 2024

(54) VERIFICATION VENDING MACHINE

(71) Applicant: EZ Vending Machines, Inc., Scottsdale, AZ (US)

(72) Inventors: Lauren Justine Smee, Pinetop, AZ (US); Jonathan Tessmar-Bell, Scottsdale, AZ (US); Frederick Lamarr Houston, Leander, TX (US)

(73) Assignee: EZ Vending Machines, Inc., Scottsdale, AZ (US)

(21) Appl. No.: 17/860,944

(22) Filed: Jul. 8, 2022

(51) Int. Cl. G07F 9/00; G07F 9/02

(52) U.S. Cl. CPC G07F 9/009; G07F 9/026; G07F 9/023

(57) ABSTRACT

According to one example, a vending machine includes an internal space that holds a plurality of age restricted products, a camera that records an image of a user, and an identification object scanner that scans an identification object provided by the user. The vending machine further includes one or more processors that receive one or more images associated with the scanned identification object, and the recorded image of the user. Based on one or more of the images, the processors can determine whether the user is a match for the identification object provided by the user, and determine whether the user has an age that satisfies an age requirement for a selected age restricted product. The vending machine can dispense the selected age restricted product based on the determinations.

### TECHNICAL FIELD

This disclosure relates generally to the field of product dispensers, and more specifically to a verification vending machine.

### BACKGROUND

Typically, a vending machine may be used to dispense products to a consumer. These traditional vending machines, however, may be deficient.

### SUMMARY

According to one example, a vending machine includes an internal space that holds a plurality of age restricted products, a camera that records an image of a user, and an identification object scanner that scans an identification object provided by the user. The vending machine further includes one or more processors that receive one or more images associated with the scanned identification object, and the recorded image of the user. Based on one or more of the images, the processors can determine whether the user is a match for the identification object provided by the user, and determine whether the user has an age that satisfies an age requirement for a selected age restricted product. The vending machine can dispense the selected age restricted product based on the determinations.

In a second example, a vending machine includes a device body having a front, a back, a first side, a second side, a top, and a bottom. The vending machine further includes an internal space positioned within the device body and that can hold a plurality of age restricted products. The vending machine also includes one or more dispensers positioned within the device body and that can selectively dispense one or more of the plurality of age restricted products from the internal space to a location in or on the device body that is accessible to a user. The vending machine also includes a touch screen display unit coupled to the front of the device body and that can receive a selection from the user of at least one of the plurality of age restricted products, a camera coupled to the front of the device body and that can record an image of the user, and an identification object scanner coupled to the front of the device body and that can scan an identification object provided by the user. The vending machine further includes one or more memory units that include one or more instructions, and one or more processors coupled to the one or more memory units. The processors can receive, from the touchscreen display unit, an indication of the selected age restricted product. The processors can also receive, from the identification object scanner, two images associated with the scanned identification object, and determine which of the two images is a front side of the scanned identification object, where the front side includes an image of a face. The processors can also receive, from the camera, the recorded image of the user, identify a face in the recorded image that is closest to the camera, where the identification is based on a measurement in-between a set of eyes of the face, and crop the recorded image around the identified face. Based on the determined image of the front side of the scanned identification object and further based on the cropped recorded image, the processors can determine whether the user is a match for the identification object provided by the user. Based on the determined image of the front side of the scanned identification object, the processors can determine whether the user has an age that satisfies an age requirement for the selected age restricted product. Following the determination that the user is the match for the identification object provided by the user and further following the determination that the user has the age that satisfies the age requirement for the selected age restricted product, the processors can further cause at least one of the one or more dispensers to dispense the selected age restricted product from the internal space to the location in or on the device body that is accessible to the user.

In a third example, a method includes receiving, by one or processors of a vending machine from a touchscreen display unit of the vending machine, an indication of a selection by a user of at least one of a plurality of age restricted products held in the vending machine. The method also includes receiving, by the one or processors of the vending machine from an identification object scanner of the vending machine, two images associated with a scanned identification object, and determining, by the one or processors of the vending machine, which of the two images is a front side of the scanned identification object, where the front side includes an image of a face. The method also includes receiving, by the one or processors of the vending machine and from a camera of the vending machine, a recorded image of the user, identifying, by the one or processors of the vending machine, a face in the recorded image that is closest to the camera, where the identification is based on a measurement in-between a set of eyes of the face, and cropping, by the one or processors of the vending machine, the recorded image around the identified face. Based on the determined image of the front side of the scanned identification object and further based on the cropped recorded image, the method further includes determining, by the one or processors of the vending machine, whether the user is a match for the identification object provided by the user. Based on the determined image of the front side of the scanned identification object, the method also includes determining, by the one or processors of the vending machine, whether the user has an age that satisfies an age requirement for the selected age restricted product. Following the determination that the user is the match for the identification object provided by the user and further following the determination that the user has the age that satisfies the age requirement for the selected age restricted product, the method also includes causing, by the one or processors of the vending machine, at least one of one or more dispensers of the vending machine to dispense the selected age restricted product from an internal space of the vending machine to the location in or on a device body of the vending machine that is accessible to the user.

### BRIEF DESCRIPTION OF THE FIGURES

For a more complete understanding of the present disclosure and its features and advantages, reference is now made to the following description, taken in conjunction with the accompanying drawings, in which:

FIG. 1 illustrates one example of a vending machine system including a vending machine.

FIG. 2 illustrates an example method for verifying identity and/or age in a vending machine.

FIG. 3 illustrates another example of a vending machine system including one or more vending machines.

### DETAILED DESCRIPTION

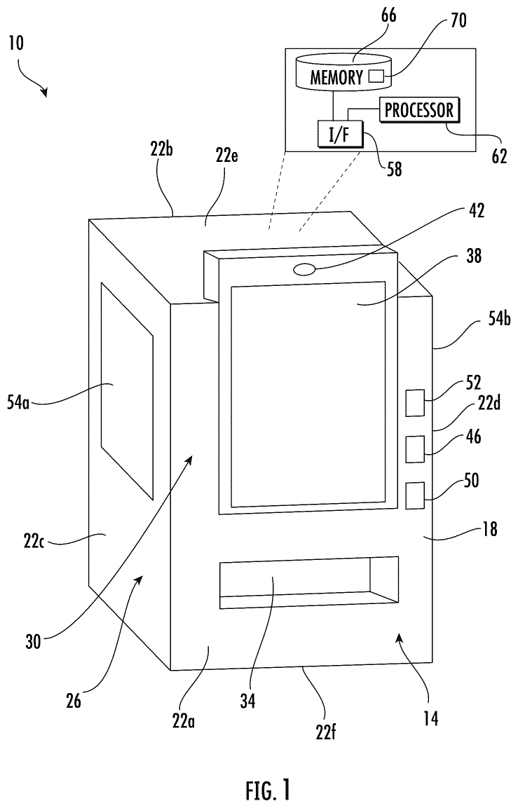

Embodiments of the present disclosure are best understood by referring to FIGS. 1-3 of the drawings, like numerals being used for like and corresponding parts of the various drawings.

Typically, a vending machine may be used to dispense products to a consumer. These traditional vending machines, however, may be deficient. For example, typical vending machines do not (and cannot) verify the identity and/or age of a purchaser. As such, these vending machines typically cannot be used to dispense age restricted products (e.g., alcohol, nicotine, cannabis). Furthermore, vending machines that can be used to dispense age restricted products are typically placed in locations where a user's age has already been verified (e.g., in a bar that requires a person to be a particular age to enter), or in locations where their use can be monitored by an employee (e.g., lottery ticket machines positioned near the checkout lines of a grocery store). Even with such locations, an underage user may still be able to purchase the age restricted product(s).

Contrary to this, the vending machine system 10 of FIGS. 1-3 may address one or more of these deficiencies. For example, the vending machine system 10 of FIGS. 1-3 includes a vending machine 14 that may verify the identity and/or age of a user before the vending machine 14 dispenses an age restricted product to the user, based on, for example, a picture of the user (e.g., a selfie taken at the vending machine 14 in real-time) and an identification object (e.g., driver's license). As such, the vending machine 14 may prevent underage users from being able to purchase age restricted products. In some examples, the verification of the identity and/or age of a user may be a simple two step process (e.g., simply provide a driver's license and take a real-time selfie photograph at the vending machine 14) that takes 30 seconds or less. As such, age restricted products can be safely sold to users in a simple, time-efficient manner, in some examples.

In the example illustrated in FIG. 1, the vending machine system 10 includes a vending machine 14. The vending machine 14 may refer to any type of vending machine that can dispense one or more products to user. Furthermore, the vending machine 14 may dispense any type of product. In the example illustrated in FIG. 1, the vending machine 14 dispenses one or more age restricted products. An age restricted product refers to a product that can only be purchased by a user who satisfies a particular age requirement (e.g., a state age requirement, a federal age requirement). Examples of such age restricted products include nicotine-based products (e.g., cigarettes), alcohol-based products (e.g., beer, liquor, wine, champagne), cannabis-based products (e.g., marijuana, edibles), lottery items (e.g., lottery tickets), adult-content products (e.g., adult magazines, adult movies), age restricted medications, any other age restricted products, or any combination of the preceding. Although the vending machine 14 is described herein as dispensing age restricted products, in some examples, the vending machine 14 may also dispense unrestricted products, such as food, water, candy. As an example of this, some of the products dispensed by the vending machine 14 may be age restricted (e.g., alcohol-based products) while other products may not be (e.g., water, soda). In such an example, the age verification steps described herein may only be utilized for the age restricted products (and not the other products).

In the illustrated example, the vending machine 14 includes a device body 18 having a front 22a, a back 22b, a first side 22c, a second side 22d, a top 22e, and a bottom 22f, all of which may define the outer boundaries of the device body 18. The device body 18 may have any size and/or shape. As one example of this, the device body 18 may have dimensions of approximately 6.5 feet high (where approximately refers to +/−15%), 4 feet wide, and 3.5 feet deep. However, the device body 18 may have any other dimensions.

In the illustrated example, the vending machine 14 further includes an internal space 26 positioned within the device body 18. The internal space 26 may hold the age restricted products (not shown) within the device body 18. The internal space 26 may be configured in any manner for holding age restricted products. For example, the internal space 26 may be separated (via partitions or grids) into a number of sections (e.g., 50 or more sections, 60 or more sections) that each include a particular type of product that may be chosen by user. For example, a first section may include a first type of beer, a second section may include a second type of beer, a third section may include a first type of liquor, and so on. The sections may fit any type of age restricted product. For example, a section of the internal space 26 may be sized to fit 12 ounce cans, tall boys, slim cans, standard bottles, mini wine/champagne bottles, standard size wine/champagne bottles, any other sized age restricted product, or any combination of the preceding.

The internal space 26 may hold any number of age restricted products. For example, the internal space 26 may hold approximately 100-600 (or more) age restricted products. Furthermore, each section of the internal space 26 may also hold any number of age restricted products. For example, a section may hold 5 age restricted products, 10 age restricted products, or any other number. Furthermore, the internal space 26 may be accessed (e.g., by opening up the front 22a) to refill the internal space 26 when quantities get low.

All or a portion of the internal space 26 may be refrigerated (or otherwise temperature/climate controlled), in some examples. Additionally, different portions of the internal space 26 may be refrigerated (or otherwise temperature/climate controlled) to different temperatures (or climates). For example, a portion of the internal space 26 that holds beer may be refrigerated to an ideal temperature for beer (e.g., 38-55 degrees Fahrenheit), while another portion of the internal space 26 that holds wine may be refrigerated to an ideal temperature for wine (e.g., 45-65 degrees Fahrenheit). In such an example, the internal space 26 may have dual zone temperature control.

In the illustrated example, the vending machine 14 further includes one or more dispensers 30 that may selectively dispense one or more of the plurality of age restricted products to the user. A dispenser 30 may refer to any structure and/or device that can dispense one or more age restricted products to the user. For example, a dispenser 30 may be a horizontal dispenser 30 that may move (e.g., push) an age restricted product towards a particular location (e.g., towards the front 22a). One example of a horizontal dispenser 30 includes a coil (or spiral retainer) that moves the age restricted product towards a particular location (e.g., towards the front 22a). As another example, a dispenser 30 may be a vertical dispenser 30 that may lower an age restricted product to a particular location (e.g., towards a bin 34 that is accessible to a user). One example of a vertical dispenser 30 includes an elevator (or elevator tray) that lowers an age restricted product to a particular location (e.g., towards a bin 34 that is accessible to a user).

In the illustrated example, the vending machine 14 utilizes both horizontal dispenser(s) 30 and vertical dispensers(s) 30. For example, the vending machine 14 may utilize a horizontal dispenser 30 (e.g., a coil) to move an age restricted product towards a particular location (e.g., towards the front 22), where the age restricted product may soft drop into the vertical dispenser 30 (e.g., an elevator). Then, the vending machine 14 may utilize the vertical dispenser 30 (e.g., the elevator) to lower the age restricted product to a particular location (e.g., towards a bin 34) that is accessible to a user.

The vending machine 14 may have any number of dispensers 30. For example, the vending machine 14 may have an individual horizontal dispenser 30 for each section of the internal space 26. As such, the vending machine 14 may have 50 or more horizontal dispensers 30. As another example, the vending machine 14 may have a single vertical dispenser 30 for the entire internal space 26, or may have an individual vertical dispenser 30 for different portions of the internal space 26 (e.g., the internal space 26 may be broken up into 5 different portions, and one of 5 different vertical dispensers 30 may be used for each portion).

In the illustrated example, the vending machine 14 further includes a bin 34 that an age restricted product may be dispensed into (e.g., by dispenser(s) 30), and that may allow the user to access the dispensed age restricted product. For example, as is illustrated, the bin 34 may be a cavity in the device body 18. When the age restricted product has been dispensed into the cavity, the user may reach into the cavity and retrieve the age restricted product. The bin 34 may have any size and/or shape. Furthermore, it may be positioned in any location of the vending machine 14. In the illustrated example, the bin 34 is positioned in the front 22a of the device body 18. In some examples, the bin 34 may extend outside of the device body 18. This may prevent the user from having to reach into the device body 18 to retrieve the age restricted product.

In the illustrated example, the vending machine 14 further includes a first display unit 38 that may provide a visual display so as to allow a user to select one or more age restricted products for purchase. The first display unit 38 may be any type of display unit may provide a visual display. For example, the first display unit 38 may be a liquid crystal display (LCD) unit, a light emitting display (LED) unit, any other display unit that may provide a visual display, or any combination of the preceding. The first display unit 38 may provide any type of display. For example, it may provide a visual display of images of each of the age restricted products that can be dispensed by the vending machine 14. As other examples, it may provide a visual display of advertisements, directions for using the vending machine 14, prompts to assist a user of the vending machine 14, any information associated with browsing/purchasing age restricted products (e.g., credit card information), any other information, or any combination of the preceding.

In the illustrated example, the first display unit 38 is a touchscreen display unit that can receive input from the user. This may allow the user to touch the touchscreen in order to select an age restricted product to purchase, to confirm purchase of an age restricted product, to input purchasing information (e.g., credit card information, reward membership information, e-mail information), to provide any other information or prompt to the vending machine 14, or any combination of the preceding. The touchscreen display unit may be any type of touchscreen, such as, for example, a resistive touchscreen, a surface acoustic wave touchscreen, a capacitive touchscreen (e.g., mutual capacitance, self-capacitance), infrared grid touchscreen, any other touchscreen or touchscreen technology, or any combination of the preceding.

The first display unit 38 may have any size and/or shape. In the illustrated example, the first display unit 38 is rectangular, and has a size that extends over half the height of the vending machine 14. For example, the first display unit 38 is a 48 inch display. The first display unit 38 may be positioned in any location on the vending machine. In the illustrated example, the first display unit 38 is coupled to the front 22a of the device body 18 of the vending machine 14.

In the illustrated example, the vending machine 14 further includes a camera 42 that may be used to record (e.g., take, capture) one or more images of a user who is utilizing the vending machine 14. The camera 42 may be any type of camera, such as a digital camera, a web camera, an embedded camera, a high-resolution camera, any other type of camera, or any combination of the preceding. In the illustrated example, the camera 42 may be used by the user to take a selfie image (e.g., an image of the user's face) in real-time. To do so, the user may be prompted that an a selfie image will be taken in a particular amount of time (e.g., 3 seconds, with a countdown displayed on the first display unit 38). When that particular amount of time has elapsed, the camera 42 may automatically record the image (e.g., take the selfie) of the user. The image(s) recorded by the camera 42 may be provided to the processors 62 for processing (discussed below). For example, the selfie image may be used to verify the identity and/or age of the user attempting to purchase the age restricted products.

The camera 42 may have any size and/or shape. Furthermore, the camera 42 may be positioned in any location on the vending machine. In the illustrated example, the camera 42 is coupled to the front 22a of the device body 18 of the vending machine 14.

In the illustrated example, the vending machine 14 further includes an identification object scanner 46 that may be used to scan an identification object provided by the user. An identification object refers to an object that may be used by the user to identify themself, and that includes a photograph and birthdate (or age) of the user. Examples of an identification object include a driver's license, an identification card (e.g., non-driver photo identification card, a military identification card, tribal card), a passport, any other object that may be used by the user to identify themself and that includes a photograph and birthdate (or age) of the user, any other identification cord or object, or any combination of the preceding. In some examples, only government issued identifications (e.g., driver's license, passports, non-driver photo identification card, a military identification card) may be used at the vending machine 14. In other examples, only driver's licenses may be used at the vending machine 14.

The identification object scanner 46 may be any scanner that may be used to scan an identification object provided by the user. In the illustrated example, the identification object scanner 46 is a E-SEEK M500 document scanner. The identification object scanner 46 may scan the identification object on one side (e.g., which may require the user to position the identification object correctly with regard to the scanner), or on both sides (e.g., both the front side and the back side, which may not require the user to position the identification object correctly with regard to the scanner). The scanned image(s) from the identification object scanner 46 may be provided to the processors 62 for processing (discussed below). For example, the scanned image(s) may be used to verify the identity and/or age of the user attempting to purchase the age restricted products.

The identification object scanner 46 may have any size and/or shape. Furthermore, the identification object scanner 46 may be positioned in any location on the vending machine 14. In the illustrated example, the identification object scanner 46 is coupled to the front 22a of the device body 18 of the vending machine 14.

In the illustrated example, the vending machine 14 further includes a payment unit that may be used by a user to pay for the age restricted products. The payment unit 50 may refer to any object and/or device that allows a user to make a payment. For example, the payment unit 50 may be a card reader (e.g., credit card, debit card, gift card), a contactless reader (e.g., radio-frequency identification (RFID), any other payment unit that may be used by a user to pay for the age restricted products, or any combination of the preceding. In the illustrated example, the payment unit 50 is a card reader (e.g., credit card reader).

The payment unit 50 may have any size and/or shape. Furthermore, the payment unit 50 may be positioned in any location on the vending machine 14. In the illustrated example, the payment unit 50 is coupled to the front 22a of the device body 18 of the vending machine 14.

Although the vending machine 14 may include one or more payment units 50, in some examples, the user may pay for age restricted products without using the payment units For example, the user may have a user profile that includes a wallet with digital payment cards. In such an example, the user may use one of the digital payment cards to pay for the age restricted products, without requiring the user to have the actual card with them. Furthermore, if the user has pre-ordered one or more of the age restricted products (as is discussed below), the user may have already selected a payment method, and the payment method may be automatically used when the user checks out with the pre-order.

In the illustrated example, the vending machine 14 further includes a user scanner 52 that may be used to scan a portion of a user's body (e.g., eyes, biometric(s)) so as to identify the user. For example, the user scanner 52 may be an iris scanner, a biometric scanner, any other scanner that can be used to scan a portion of a user's body so as to identify the user, or any combination of the preceding. In the illustrated example, the user scanner 52 is an iris scanner, such as iris scanner from ANVIZ. In some examples, the user scanner 52 may be used to identify a particular user. For example, the user may have previously set up a user profile for the user (e.g., when the user last visited the vending machine 14, on-line), and this user profile may indicate the identity of the user, the age of the user, an identifier of the user (e.g., the unique iris of the user), and any other information about the user (e.g., stored credit card to use for a purchase, favorite age restricted products). In such an example, the user may only need to scan their iris(es) at the user scanner 52, and the vending machine 14 may be able to access this user profile to verify the identity and/or age of the user. As such, the user may not need to submit an identification object or take a selfie with the vending machine 14. Instead, the user scanner 52 may allow the user to skip all of this, and purchase one or more age restricted products simply by scanning their unique iris(es). In other examples, the user scanner 52 may be used in addition to also requiring the user to submit an identification object and take a selfie with the vending machine 14. In such examples, the user scanner 52 may provide further verification.

The user scanner 52 may have any size and/or shape. Furthermore, the user scanner 52 may be positioned in any location on the vending machine 14. In the illustrated example, the user scanner 52 is coupled to the front 22a of the device body 18 of the vending machine 14.

In the illustrated example, the vending machine 14 further includes a second display unit 54a and a third display unit 54b, each of which may provide a visual display. The second and third display units 54a and 54b may each be any type of display unit that may provide a visual display. For example, the second and third display units 54a and 54b may each be a LCD unit, a LED unit, any other display unit that may provide a visual display, or any combination of the preceding. The second and third display units 54a and 54b may each provide any type of display. For example, the second and third display units 54a and 54b may each provide a visual display of images of each of the age restricted products that can be dispensed by the vending machine 14, advertisements, any other information, or any combination of the preceding. In the illustrated example, the second and third display units 54a and 54b each provide a visual display of one or more advertisements. The visual display may change periodically (e.g., every few seconds, minutes, hours, in accordance with a schedule, in real-time when a new advertisement is sent to the vending machine 14). Furthermore, the second and third display units 54a and 54b may each provide the same visual display, or may display different visual displays (e.g., different advertisements).

The second and third display units 54a and 54b may each have any size and/or shape. In the illustrated example, the second and third display units 54a and 54b are each rectangular, and each have a size that extends over half the height of the vending machine 14. The second and third display units 54a and 54b may each be positioned in any location on the vending machine 14. In the illustrated example, the second display unit 54a is coupled to the first side 22c of the device body 18 of the vending machine 18, and the third display unit 54b is coupled to the second side 22d of the device body 18 of the vending machine 18.

In the illustrated example, the vending machine 14 further includes one or more network interfaces 58, one or more processors 62, and one or more memory units 66. The vending machine 14 may include any number of network interfaces 58, processors 62, and memory units 66.

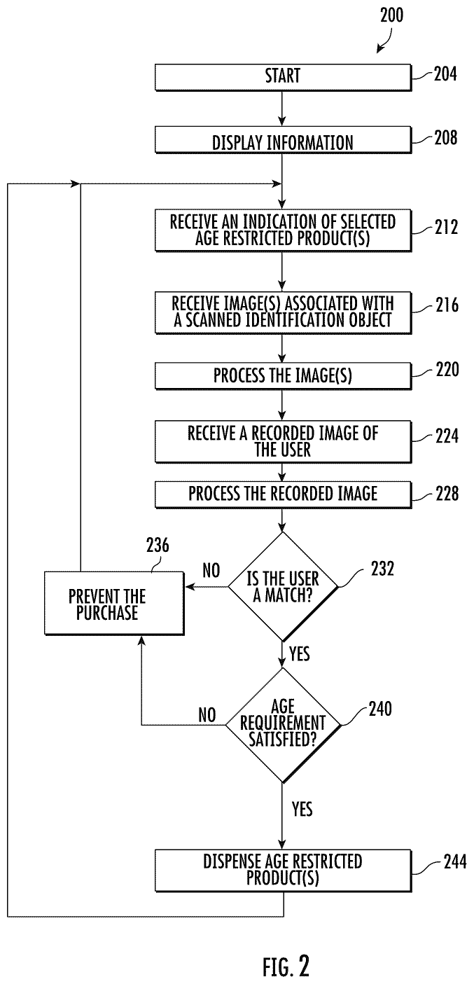

A network interface 58 represents any suitable device operable to receive information from a communication network (e.g., a cellular network), transmit information through the communication network, perform processing of information, communicate with other devices (or components), or any combination of the preceding. A network interface 58 represents any port or connection, real or virtual, including any suitable hardware and/or software, including protocol conversion and data processing capabilities, to communicate through a local area network (LAN), a metropolitan area network (MAN), a wide area network (WAN), a wireless wide area network (WWAN) (e.g., 2G, 3G, 4G LTE, 5G cellular network technologies), or other communication system that allows vending machine 14 to exchange information with a communication network and/or one or more devices or components (over a communication network). Examples of this communication are discussed below with regard to FIG. 2.

A processor 62 communicatively couples to the network interface(s) 58 and memory unit(s) 66, and controls the operation and administration of the vending machine 14 by processing information received from the network interface(s) 58 and/or memory unit(s) 66. A processor 62 includes any hardware and/or software that operates to control and process information. For example, processor(s) 62 execute a vending machine management application 70 to control the operation of the vending machine 14. A processor 62 may be a programmable logic device, a microcontroller, a microprocessor, any other processing device, or any combination of the preceding.

A memory unit 66 stores, either permanently or temporarily, data, operational software, or other information for processor(s) 62. A memory unit 66 includes any one or a combination of volatile or non-volatile local or remote devices suitable for storing information. For example, a memory unit 66 may include random access memory (RAM), read only memory (ROM), magnetic storage devices, optical storage devices, any other information storage device, or any combination of the preceding. While illustrated as including particular information modules, memory unit 66 may include any suitable information for use in the operation of the vending machine 10. In the illustrated example, memory unit 66 includes the vending machine management application 70. Vending machine management application 70 represents any suitable set of instructions, logic, or code embodied in a computer-readable storage medium and operable to facilitate the operation of the vending machine 14.

In some examples, the vending machine 14 may further include one or more sensors for sensing the products stored by the vending machine 14. As one example of this, the vending machine 14 may include one or more sensors that may sense the number of products stored in the internal space 26 of the vending machine 14. These sensors may determine how many products are currently stored in a portion (e.g., a section, one or more sections) of the internal space 26. For example, the sensors may determine that section 1 (e.g., in column 1, row 1) of the internal space 26 only includes two more products (e.g., two beers). In such an example, the sensors may be utilized to provide the vending machine 14 (and/or system 10) of an accurate count of the products still included in the internal space 26. This may allow the vending machine 14 (and/or system 10) to keep track of inventory in real-time and may further allow re-fill requests to be transmitted in real-time. The sensor may be any type of sensor that can sense the number of products, such as a weight sensor that senses weight, or any other type of inventory sensor. The sensor may be positioned in any location that allows it to sense the number of products. For example, a sensor may be positioned in each section of the internal space 26.

In some examples, the vending machine 14 may further include one or more product scanners for scanning and tracking products dispensed by the vending machine 14. When a product is dispensed, the product scanner may scan the product so that the vending machine 14 (and/or system 10) may determine the identity of the product that is being dispensed. In some examples, this may allow the dispensed product to be associated with the particular user that purchased and received the product. This association may be used to track the exact product that was purchased, and who purchased it (e.g., for regulatory reasons). In some examples, the product scanner may scan a unique identifier included on or in the packaging of the product. The product scanner may be any type of scanner that can scan a product, such as, for example, an RFID scanner. The product scanner may be positioned in any location that allows it to scan a product being dispensed. For example, the product scanner may be positioned at a location inside the vending machine 14 in or near the bin 34.

In some examples, the vending machine 14 may further include one or more additional user interfaces to assist a user when the user is interacting with the vending machine 14. For example, the vending machine 14 may include one or more speakers that may emit sounds in the form of instructions (e.g., voice commands) that can assist the user. For example, the speakers may emit sounds that tell the user to insert their identification object, that provide the user with an audible countdown until the selfie photograph is record (e.g., 3, 2, 1), that provide any other audible instruction or prompt, or any combination of the preceding.

Modifications, additions, omissions, and/or substitutions may be made to the vending machine system 10, the components of the vending machine system 10, and/or the functions of the vending machine system 10 without departing from the scope of the specification. For example, the vending machine 14 of system 10 may include any number of its components (e.g., any number of cameras 42, payment units 50, and/or any of the other components). Also, any suitable logic may perform the functions of system 10 and the components and/or devices within system 10. Furthermore, one or more components of system 10 may be separated, combined, and/or eliminated. For example, the vending machine 14 may not include the user scanner 52 and/or one or more of the other components described above.

FIG. 2 illustrates an example method for verifying identity and/or age in a vending machine. In the illustrated example, the steps of method 200 of FIG. 2 are performed by the vending machine 14 of FIG. 1. However, the steps of method 200 may be utilized to verify identity and/or age in any other vending machine. Additionally, one or more of the steps of method 200 (and/or any of the other functionalities and/or components discussed herein) may be utilized to verify identity and/or age in any other device, such as, for example, a parcel locker (e.g., for storing pre-delivered packages for pick-up), a storage locker, any other dispensing or delivery device, any other device that may utilize identification and/or age verification, any other device, or any combination of the preceding.

The method 200 begins at step 204. At step 208, information is displayed on the first display unit 38, the second display unit 54a, and/or the third display unit 54b. Any information may be displayed on any of the first display unit 38, the second display unit 54a, and/or the third display unit 54b. For example, the information may be a visual display of images of each of the age restricted products that can be dispensed by the vending machine 14, a visual display of advertisement(s), directions for using the vending machine 14, prompts to assist a user of the vending machine 14, any information associated with browsing/purchasing age restricted products, any other information, or any combination of the preceding. Also, the first display unit 38, the second display unit 54a, and the third display unit 54b may display the same information, or different information. As one example of this, the first display unit 38 may display a visual display of images of each of the age restricted products that can be dispensed by the vending machine 14, and the second display unit 54a and the third display unit 54b may display a visual display of advertisement(s).

The information may be displayed for any reason. For example, the information may be displayed in response to the vending machine 14 being turned on, in accordance with a predetermined schedule, any other reason, or any combination of the preceding. The processor(s) 62 may cause the information to be displayed on the first display unit 38, the second display unit 54a, and/or the third display unit 54b. For example, for each of the display units 38/54a/54b, the processor(s) 62 may retrieve the information from the memory units 66, and may transmit the information for display on the respective display unit 38/54a/54b.

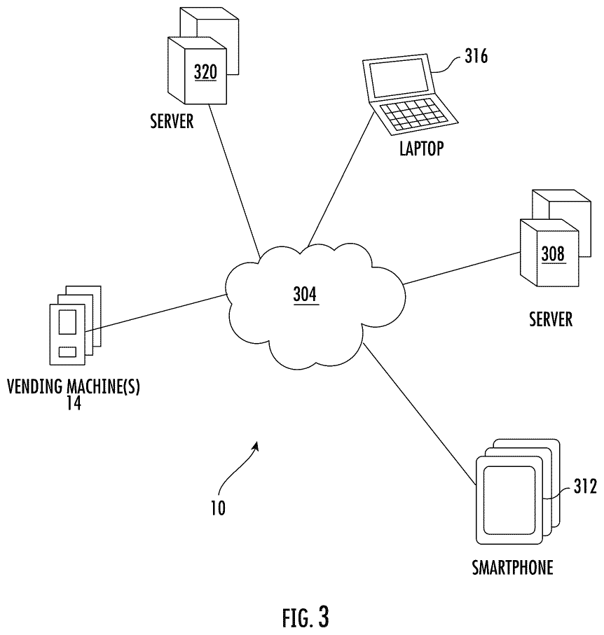

At step 212, an indication of a selection of one or more age restricted products is received. The indication may be received for any reason. For example, a user at the vending machine 14 may want to purchase one or more age restricted products, and may therefore select on the vending machine 14 which age restricted products they want to purchase. The user may select an age restricted product in any manner For example, the user may press on a portion of the touchscreen display unit 38 that corresponds to a displayed image of a particular age restricted product (e.g., an image of a particular brand of beer). In some examples, the user may also select additional options on the touchscreen display unit 38, such as “View All Products”, “Filter Products” (e.g., by price, by category, etc.), “Favorite Products”, “Add to Cart”, “Check Out”, “Pay Now”, “Pre-Order”, “Reserved”, and/or any other options. As an example of this, the user may select “Pre-Order” to receive a list of one or more age restricted products that have been pre-ordered and reserved for the user, and then the user may select to purchase these pre-ordered products. In some examples, the indication of the selection of one or more age restricted products may be received as a result of a user selecting a “Pre-Order” section (as is discussed in FIG. 3), or the vending machine 14 determining that there is a “Pre-Order” associated with that particular identified user.

In some examples, the indication of a selection of one or more age restricted products may be received by the processor(s) 62 from the first display unit 38. For example, a user may have selected an age restricted product on the first display unit 38 (e.g., when the user touches the touchscreen of the first display unit 38), and an indication of this selection (e.g., data that identifies this selection, or allows the selection to be identified) may be transmitted to the processor(s) 62.

At step 216, one or more images associated with a scanned identification object are received. The images may be received for any reason. For example, in order to purchase an age restricted product, a user may provide their identification object (e.g., their driver's license) to the identification object scanner 46 (e.g., by inserting or sliding the driver's license into identification object scanner 46), causing it to be scanned. This may occur following a prompt from the first display unit 38 to the user to provide the identification object.

In some examples, the one or more images associated with a scanned identification object may be received by the processor(s) 62 from the identification object scanner 46. For example, the identification object scanner 46 may scan the identification object, creating (or otherwise recording) one or more images of the identification object. Then these image(s) may be transmitted to the processor(s) 62 for processing. The identification object scanner 46 may create any number of images of the identification object, and may also transmit any number of images to the processor(s) 62. In the illustrated example, the identification object scanner creates two images of the identification object (e.g., one image of the front of the driver's license, and one image of the back of the driver's license), and these two images are transmitted to the processor(s) 62.

At step 220, the one or more images associated with a scanned identification object are processed. The image(s) may be processed in any manner As one example, the image(s) may be cropped or manipulated (e.g., the image may be lightened or darkened) in any manner As another example, the number of images may be reduced to a single image. In such an example, the processor(s) 62 may determine which single image to utilize. In some examples, the determined single image is the image that includes an image of a face of the user (e.g., the front of the driver's license). The determination may be made in any manner For example, if the processor(s) 62 received two images (e.g., one image of the front of the driver's license, and one image of the back of the driver's license), the processor(s) 62 may determine which of the images is the front of the identification object. To do so, the processor(s) 62 may compare the received images to a library of stored images (e.g., examples of driver's licenses from 50 different states), so as to determine which image is the front of the identification object that includes an image of the face of the user, in some examples. In other examples, the processor(s) 62 may analyze the image (e.g., using artificial intelligence, and the training of neural networks) to determine which image includes an image of the face of the user. In further examples, the user may be asked to select which scanned image includes an image of the face of the user.

At step 224, a recorded image of the user is received. The recorded image may be received for any reason. For example, in order to purchase an age restricted product, a user may be prompted to pose for a selfie photograph at the vending machine 14 in real-time, and then the selfie photograph may be recorded by the camera 42. In such an example, the user may be prompted that a selfie image will be taken in a particular amount of time (e.g., 3 seconds, with a countdown displayed on the first display unit 38). When that particular amount of time has elapsed, the camera 42 may automatically record the image (e.g., take the selfie) of the user.

In some examples, the recorded image of the user may be received by the processor(s) 62 from the camera 42. For example, after the camera 42 records the selfie photograph of the user as an image, the recorded image may be transmitted to the processor(s) for processing. The camera 42 may create any number of recorded images of the user, and may also transmit any number of images to the processor(s) 62. In the illustrated example, the camera 42 records a single image of the user, and this single recorded image is transmitted to the processor(s) 62.

At step 228, the recorded image of the user is processed. The recorded image may be processed in any manner As one example, the recorded image may be cropped or manipulated (e.g., the image may be lightened or darkened) in any manner

As another example, the recorded image may be processed to determine a particular face in the image. In such an example, the image may be processed to determine a face in the image that is closest to the camera 42. This determination may be made in any manner As one example of this, the processor(s) 62 may measure the distance between eyes on each face detected in the image. In such an example, the detected face that has the greatest distance in-between a set of eyes may be determined to be the closest face in the image. In other examples, the image may also (or alternatively) be processed to determine a face in the image that is center-most in the image. This determination may be made in any manner, such as by measuring the distance from the center of the set of eyes to the center of the image. In such an example, the detected face that has the smallest distance from the center of the image may be determined to be the center-most face in the image.

In some example, after the processor(s) 62 has determined a particular face in the image, the processor(s) 62 may crop the image around the determined face. This may prevent other faces in the image from effecting the verification of the identity and/or age of the user. This cropping of the image around the determined face may be performed in any manner.

At step 232, a determination is made regarding whether the user is a match of the identification object provided by the user. This determination may be made based on the processed recorded image of the user (from step 228) and the processed image of the scanned identification object (from step 220). For example, the processed image of the user (e.g., the processed selfie photograph of the user) may be analyzed to see if it matches the image of the face included on the processed image of the scanned identification object (e.g., the image of the face on the driver's license).

The determination of a match may be performed in any manner For example, the processor(s) 62 may analyze the images to determine a match. As an example of this, the processor(s) 62 may utilize an artificial intelligence biometric facial recognition process (or processes) on both images (e.g., the real-time selfie taken at the vending machine 14, and the image of the face on the driver's license). As one example of this, the processor(s) 62 may analyze the features of the face (in each image) and distances between those feature points in the face (in each image), to determine whether the features and distances match. In such an example, the processor(s) 62 may utilize these results to determine whether there is a match.

As another example, the processor(s) 62 may not analyze the images. Instead, in some examples, the processor(s) 62 may transmit the images to a third party analyzer, which may then transmit the results of the analysis back to the processor(s) 62. In such an example, the processor(s) 62 may utilize these results to determine whether there is a match. One example of a third party analyzer includes Core API by ID Analyzer. In some examples, the images may be transmitted to the third party analyzer via an application programming interface (API).

The results of the analysis (e.g., analysis by the processors 62, analysis by a third party) may be utilized in any manner in order to determine whether there is a match between the two images. For example, the analysis may result in a confidence score that is determined by analyzing the images (e.g., a score regarding the similarity between the features and distances in both faces). In such an example, if the confidence score is greater than or equal to a predetermined score, the images may be determined to be a match. Alternatively, if the confidence score is less than the predetermined score, the images may be determined to not be a match. The predetermined score may be any value. For example, the predetermined score may be 60 percent (e.g., the features and distances in both faces are 60 percent identical). In other examples, the predetermined score may be any score in the range of 50-100 percent, such as, for example, 97 percent.

If the user is determined to not be a match for the identification object at step 232, the method 200 move to step 236, where the user is prevented from purchasing the age restricted product(s). The method 200 then moves back to step 212 for a new user (or for the previous user to try again). In some examples, the vending machine 14 may prevent the previous user from trying multiple times in a row.

Alternatively, if the user is determined to be a match for the identification object at step 232, the method moves to step 240.

At step 240, a determination is made regarding whether the age of the user satisfies an age requirement for the selected age restricted products. This determination may be made based on the processed image of the scanned identification object (from step 220). For example, the processed image of the scanned identification object (e.g., the front side of the user's driver's license) may be analyzed to see if it indicates that the user has an age (e.g., age 25) that satisfies an age requirement (e.g., an age requirement of 21) for the selected age restricted products (e.g., alcoholic beer).

The determination regarding satisfaction of an age requirement may be performed in any manner For example, the processor(s) 62 may analyze the processed image of the scanned identification object (e.g., the front side of the user's driver's license) to determine the age of the user, and then this age may be compared with the age requirement to determine whether the age of the user satisfies (e.g., is greater than or equal) to the age requirement. The analysis may be performed in any manner For example, the processor(s) 62 may perform optical character recognition (OCR) on the processed image in order to determine the birth date of the user (e.g., using artificial intelligence, and the training of neural networks). Then the processor(s) 62 may use this birth date to determine the current age of the user, and this current age may be compared to the age requirement to determine whether the age of the user satisfies (e.g., is greater than or equal) to the age requirement.

As another example, the processor(s) 62 may not analyze the processed image of the scanned identification object (e.g., the front side of the user's driver's license) to determine the age of the user. Instead, in some examples, the processor(s) 62 may transmit the processed image of the scanned identification object (e.g., the front side of the user's driver's license) to a third party analyzer, which may then transmit the results (e.g., birth date) of the analysis back to the processor(s) 62. In such an example, the processor(s) 62 may utilize these results (e.g., birth date) to determine the current age of the user, and this current age may be compared with the age requirement to determine whether the age of the user satisfies (e.g., is greater than or equal) to the age requirement. One example of a third party analyzer includes Core API by ID Analyzer. In some examples, the image may be transmitted to the third party analyzer via an application programming interface (API).

As is discussed above, the results of the analysis (e.g., analysis by the processors 62, analysis by a third party) may include a birth date of the user. In other examples, the results may include the current age of the user (instead of the birth date). In further examples, the results of the analysis may additionally include any other information included on the processed image of the scanned identification object (e.g., the front side of the user's driver's license). For example, the results may additionally include the user's name (e.g., first, last, middle), the user's address, the expiration date of the identification object, restrictions included on the identification object, any other information, or any combination of the preceding. In some examples, the analysis of the scanned identification object may include additional determinations. For example, the analysis (e.g., by the processor(s) 62 and/or the third party analyzer) may determine whether the identification object is fake (e.g., by comparing it a library of known identification objects), whether the identification object is expired, whether the identification object has been altered, any other determination, or any combination of the preceding. In some examples, the user may be determined to have not satisfied the age requirement if it is determined that the identification object is fake, that the identification object is expired, or that the identification object has been altered. In such examples, the user is prevented from purchasing any of the age restricted products.

If it is determined that the user's age does not satisfy the age requirement for the selected age restricted products, the method 200 moves to step 236, where the user is prevented from purchasing the age restricted product(s). The method 200 then moves back to step 208 for a new user (or for the previous user to try again). In some examples, the vending machine 14 may prevent the previous user from trying multiple times in a row.

Alternatively, if it is determined that the user's age does satisfy (e.g., is greater than or equal) the age requirement for the selected age restricted products, the method moves to step 244. In some examples, it may be determined that the user's age satisfies the age requirement for some of the selected age restricted products (e.g., the user is age 19 and can buy cigarettes), but not others (e.g., the user is age 19 and cannot buy alcohol). In such examples, the method 200 may move to step 244 for only the age restricted products that the user satisfied the age requirement for (e.g., the user may buy the cigarettes, but not the alcohol).

At step 244, the selected age restricted products are dispensed to the user. In some examples, the selected age restricted products are dispensed if (and only if) the user is determined to match the identification object provided by the user, and if the user is determined to have an age that satisfies the age requirement for the selected age restricted products. In other examples, the selected age restricted products can be dispensed if one or more of these determinations is not made, such as via an employee or manager override. In such an example, the employee or manager may review the identification object, determine that the vending machine 14 incorrectly denied the user, and override the denial.

The selected age restricted products may be dispensed in any manner For example, the processor(s) 62 may cause the selected age restricted products to be dispensed by, for example, transmitting instructions or commands to one or more of the dispensers 30 to cause the dispensers 30 to dispense each of the selected age restricted products from the internal space 26 to the bin 34 accessible to the user.

In some examples, additional processes may be performed before the selected age restricted products are dispensed. For example, the selected age restricted products may not be dispensed until the user has paid for the selected age restricted products (e.g., via payment unit 50).

After the selected age restricted products are dispensed to the user (at step 244), the process 200 moves back to step 212 for a new user (or for the previous user to try again). In some examples, the vending machine 14 may prevent the previous user from purchasing multiple age restricted products within a particular time frame and/or at a particular frequency. For example, the vending machine 14 may only allow the user to purchase a set amount of age restricted products (e.g., 1, 2, 5) in a particular time frame (e.g., 1 hour, 12 hours, 24 hours). In some examples, this restriction may be overridden, such as by an employee or manager override.

Modifications, additions, or omissions may be made to the method 200. For example, one or more steps of method 200 may be optional, or may not be performed. As one example of this, steps 216-240 of method 200 may not be performed for a user that utilizes the user scanner 52 (e.g., the user scans their irises), because a user profile associated with those unique irises may be used to verify the identity and/or age of the user. As a further example, the steps of method 200 may be performed in parallel or in any suitable order. As one example of this, a user may need to provide their identification object (for step 216) and their selfie photograph (for step 224), and the identity and/or age of the user may need to be verified, at the beginning of the method 200 (e.g., before an age restricted product is selected). As another example, additional steps may be added to method 200, such as one or more of the steps or functionalities discussed below with regard to FIG. 3.

FIG. 3 illustrates another example of the vending machine system 10. In the illustrated example, the vending machine system 10 includes one or more vending machines 14. The vending machine 14 of FIG. 3 may be substantially similar to the vending machine 14 of FIGS. 1-2. The vending machine system 10 may include any number of vending machines 14, such as one vending machine 14, ten vending machines 14, hundreds of vending machines 14, thousands of vending machines 14, or any other number of vending machines 14. The vending machines 14 may be located anywhere. For example, a vending machine 14 may be located in a building (e.g., in a store), outside of a building (e.g., outside of a store), at an outside area (e.g., at an outside festival), or any other location. Two or more of the vending machines 14 may be positioned together or in close proximity to each other. For example, a particular building (e.g., a particular store) may have three vending machines 14 positioned inside and/or outside of the store. In such an example, one or more employees of the building may supervise the functioning of the vending machines 14.

In the illustrated example, the vending machine system 10 further includes one or more networks 304. A network 304 may be an example of the communication network discussed above. The network 304 represents any suitable network operable to facilitate communication between the components of the vending machine system 10. The network 304 may include any interconnecting system capable of transmitting audio, video, signals, data, messages, or any combination of the preceding. The network 304 may include all or a portion of a public switched telephone network (PSTN), a public or private data network, a LAN, a MAN, a WAN, a WPAN, a local, regional, or global communication or computer network, such as the Internet, a wireline or wireless network, an enterprise intranet, or any other suitable communication link, including combinations thereof, operable to facilitate communication between the components. In some example, the communication network may include a WPAN (which may include, for example, Wi-Fi (IEEE 802.11)), a cellular communication network, an infrared communication network, any other wireless network operable to facilitate communication between the components, or any combination of the preceding. The vending machine system 10 may include any number of networks 304. Furthermore, components of the vending machine system 10 may use different networks 304 to communicate, or may use the same network 304.

In the illustrated example, the vending machine system 10 further includes one or more vending machine management systems 308. The vending machine management system 308 may be any device that may communicate with one or more other components of the vending machine system 10 in order to manage one or more functions of the vending machine system 10. For example, the vending machine management system 308 may be (or may include) a network server, any suitable remote server, a mainframe, a host computer, a workstation, a web server, an application server, a personal computer, a laptop, a mobile telephone (such as a Smartphone), an electronic notebook, a tablet (such as an IPAD), a personal digital assistant, a file server, any other computing or processing device, or any combination of the preceding. The functions of vending machine management system 308 may be performed by any suitable combination of one or more servers or other components at one or more locations. In an example where the vending machine management system 308 is a server, the server may be a private server, and the server may be a virtual or physical server. The server may include one or more servers at the same or remote locations. Also, the vending machine management system 308 may be (or may include) any suitable component that functions as a server. In the illustrated example, the vending machine management system 308 is one or more servers.

As is discussed above, the vending machine management system 308 may communicate with one or more other components of the vending machine system 10 in order to manage one or more functions of the vending machine system 10. For example, the vending machine management system 308 may communicate with the vending machines 14 in order to provide information to the vending machines 14. Such provided information may include advertisements to be displayed on the vending machines 14, software updates, user profiles, pre-orders made by a user, any other information, or any combination of the preceding.

As another example, the vending machine management system 308 may communicate with the vending machines 14 in order to receive information from the vending machines 14. Such received information may include sales information (e.g., number of sales, data and/or demographic information of users who purchased products), status information (e.g., product re-fill requests, errors in the function of the vending machine 14), any other information, or any combination of the preceding.

As a further example, the vending machine management system 308 may communicate with one or more user devices 312 (discussed below). Such communication may allow a user to set up a user profile (or update a user profile), pre-order various age restricted products, search for nearby vending machines 14 (e.g., find the nearest vending machine 14, view a map of vending machines 14, filter a list of vending machines 14 by categories (alcohol, cannabis) and product availability), or perform any other function. In some examples, the vending machine management system 308 may be a web server and/or application server that may host a one or more webpages or applications (“apps”) associated with the vending machine management system 308. These webpages/apps may allow the user to communicate with the vending machine management system 308.

As another example, the vending machine management system 308 may communicate with one or more administration devices 316. Such communication may allow a manager (or other user) to view one or more reports about one or more vending machines 14 (e.g., view sales data, view data and/or demographic information of users who have purchased products), and/or allow the manager to transmit information to the vending machine management system 308 (e.g., transmit advertisements to be displayed on the vending machines 14). In some examples, the vending machine management system 308 may be a web server and/or application server that may host a one or more webpages or apps associated with the vending machine management system 308. These webpages/apps may allow the manager to communicate with the vending machine management system 308.

In the illustrated example, the vending machine system 10 further includes one or more user devices 312. The user device 312 may be any device that may communicate with the vending machine management system 308. For example, the user device 312 may be (or may include) a personal computer, a laptop, a mobile telephone (such as a Smartphone), an electronic notebook, a tablet (such as an IPAD), a personal digital assistant, any other computing or processing device, or any combination of the preceding. In the illustrated example, the user device 312 is a Smartphone that is communicating with the vending machine system 10 via a webpage or an app.

The user device 312 may allow the user to communicate with the vending machine management system 308 for any purpose, examples of which are described herein.

In some examples, the user device 312 may be utilized by the user to set up or manage a user profile. The user profile may be a profile the identifies a particular user. For example, the user profile may include the user's name, address, birth date, age, other information from the identification object (e.g., driver's license number, an image of the user's face), favorite products, preferred billing (e.g., a credit card number, thereby allowing the user to pay at the vending machine 14 even if they do not have their credit card with them), identification feature(s) (e.g., user's biometric(s), user's iris(es)) that allows the user to be identified using the user scanner 52, any other information about the user, or any combination of preceding. In some examples, setting up the user profile may require an identity and/or age verification process, similar to that discussed above in FIG. 2. For example, when setting up a user profile, the user may send in an image of their identification object and also an image of their face. These images may be used to verify the identity and/or age of the user (for the user profile). As such, a verified identity and/or age of the user may be associated with identification feature(s) (e.g., user's biometric(s), user's iris(es)) of the user in the user profile, which may allow the user to skip verification at the vending machine 14 when the user successfully scans a portion of their body (e.g., user's biometric(s), user's iris(es)). In other examples, the verified the identity and/or age of the user (in the user profile) may be used to allow the user to pre-order particular products.

When the user is utilizing the vending machine 14, the vending machine 14 may access this user profile (e.g., access a local version of the user profile, communicate with the vending machine management system 308 to receive the user profile) so that the user profile can be used when purchasing age restricted products. To access the user profile, the user may be prompted to scan their identification object or a portion of their body (e.g., the user's iris), or the user may be prompted to enter a code associated with the user profile (e.g., a unique code, the user's full name) The information provided by the user may be cross-referenced with information in available user profiles, so as to allow the vending machine 14 to locate and access the user profile associated with the use. The user profile may then be used by the vending machine 14 to provide additional features to the user, in some examples. For example, the vending machine 14 may allow a user to skip verification at the vending machine 14 when the user successfully scans a portion of their body. As another example, the vending machine 14 may allow a user to retrieve pre-ordered products. In some examples, the user profile may be a global user profile that be accessed by any and all vending machines 14, allowing the user to access any and all vending machines 14 (without further registration). In some examples, the user profile may be set up when the user is at a vending machine 14 (as opposed to (or in addition to) on-line using the user device 312).

In some examples, the user device 312 may be utilized by the user to pre-order one or more age restricted products. For example, the user may use the user device 312 to access a webpage or app associated with vending machine management system 308, and then the user may select one or more age restricted products to pre-order on the webpage or app. Additionally, the user may also select a particular date/time to pick up the pre-order, and also may select a particular vending machine 14 to pick up the pre-order. In some examples, the pre-order will be associated with the user profile of the user.

When the user goes to the vending machine 14, the user may select a “Pre-Order” selection on the vending machine 14, and then the user may identify themself (e.g., by providing an identification object) and take a real-time selfie of themself. The vending machine 14 may then perform one or more steps of method 200 to verify the identity and/or age of the user. Following this verification, the vending machine 14 may cross-reference the verified identity (e.g., from the identification object) with an identifier in the pre-order. For example, the vending machine 14 may cross-reference the name and/or image on the provided driver's license with the name and/or image in the user profile. If they do not match, the transaction may be cancelled. On the other hand, if they do match, the pre-ordered items may be selected for purchase. In such an example, the pre-ordered items may be displayed in the “Check-Out Cart” of the vending machine 14, and the user can proceed with paying for the pre-ordered items.

Although the pre-order function has been discussed above as requiring a user profile, in other examples, a user profile may not be needed in order to make a pre-order. As one example of this, the user may only have to provide information (e.g., the user's name, the user's address, an image of the user's identification object) to make a pre-order. This same information may then be provided at the vending machine 14 when the user goes to pick up the order, so that the vending machine 14 can cross-reference the provided information with the pre-order. If they do not match, the transaction may be cancelled. On the other hand, if they do match, the pre-ordered items may be selected for purchase. In some examples, the vending machine 14 may also perform one or more steps of method 200 to verify the identity and/or age of the user.

In some examples, the pre-order process may result in the vending machine 14 reserving particular age restricted products for a particular user. If the user does not show up to pick up the age restricted products within a particular amount of time (e.g., 1 hour after the reserved pick-up time), the pre-order may be cancelled.

In the illustrated example, the vending machine system 10 further includes one or more administration devices 316. The administration device 316 may be any device that may communicate with the vending machine management system 308. For example, the administration device 316 may be (or may include) a personal computer, a laptop, a mobile telephone (such as a Smartphone), an electronic notebook, a tablet (such as an IPAD), a personal digital assistant, any other computing or processing device, or any combination of the preceding. In the illustrated example, the administration device 316 is a laptop computer that is communicating with the vending machine management system 308 via a webpage.

The administration device 316 may allow a manager, employee, or other user to communicate with the vending machine management system 308 for any purpose, examples of which are described herein. For example, it may be the job of a manager and/or employee to monitor and manage a particular number of vending machines 14. To do so, the manager and/or employee may communicate with the vending machine management system 308 (via the administration device 316) to perform such monitoring and management, remotely. As one example of this, the manager may transmit particular advertisements (e.g., targeted advertisements) and/or a schedule for particular advertisements to the vending machine management system 308, so that they can be displayed on particular vending machines 14 (in accordance with a particular schedule, via a calendaring feature, for example). As another example, the manager may receive and review reports (e.g., a cloud based dashboard) about one or more vending machines 14 (e.g., view sales data, view data and/or demographic information of users who have purchased products). A manager and/or employee may monitor and manage any number of vending machines 14.

The vending machine system 10 may include any number of managers and/or employees, and the managers/employees may have multiple different levels of access to the vending machine management system 308. As one example of this, the vending machine system 10 may include one or more global managers (or administrators). Such a global manager may have full permission with regard to the vending machine management system 308 and the vending machines 14. This may allow the global manager to: (1) view statistics, such as total sales, top products, average order value, sign-ups (all of which can be filtered by retailer, location, dates); (2) upload advertisements (e.g., upload rich multimedia (images, video) that the vending machine(s) 14 will display after download (e g , immediate download, download after midnight); (3) upload advertisement schedules (e.g., create a content calendar that schedules out one or more of the advertisements); (4) manage vending machines 14 (e.g., by location, by area (such as a city), by a particular retailer, by a particular venue); (5) manage who can be a manager and/or employee; (6) manage users, such as viewing user data (e.g., user name, age, verification status, ID, selfie and verification results), deleting users (e.g., delete user profile but allows user to sign up again), and blocking user (e.g., blocks the user and prevents future registration); (7) manage e-mails sent by the vending machine management system 308 (e.g., manage who receives e-mails, manage criteria that prompt the sending of an e-mail), where example e-mails include e-mails regarding new user registration, order placed, user registered but has not placed an order in 48 hours, placed an order but has not ordered again in 14 days, and mail survey 8 hours after their first order; (8) manage retailers that have vending machines 14 (e.g., activate an admin dashboard view for a specific retailer, manage the permissions of a specific retailer); (9) view the health/status of all vending machines 14; (10) perform any other functions; or (11) any combination of the preceding.

As another example of this, the vending machine system 10 may include one or more retail managers (or administrators). Such a retail manager may be manager of a subset of vending machines 14 (e.g., the retail manager may own or work for a company that owns different vending machines 14). The retail manager may have partial permissions with regard to the vending machine management system 308 and the vending machines 14. This may allow the global manager to: (1) perform all or a portion of the activities listed above for the global manager, but with a limited scope to just the vending machines 14 associated with that retail manager; (2) manage the catalog of the vending machines 14 associated with that retail manager (e.g., create a data dictionary of all of your products and use them across all of your vending machines 14 without having to create them again); (3) manage stock at all of the vending machines 14 associated with that retail manager (e.g., manage what age restricted products are in your vending machines 14, stock the vending machines 14); (4) manage planogram for all of the vending machines 14 associated with that retail manager (e.g., a unique and simple method to stock the machine virtually, so that the current stock is shown as available online and at the vending machines 14); (5) perform any other functions; or (6) any combination of the preceding.

In the illustrated example, the vending machine system 10 further includes one or more third party systems 320. The third party system 320 may be any device that may communicate with one or more vending machines 14, one or more vending machines managements systems 308, or any other component of the vending machine system 10 to provide third party services. For example, the third party system 320 may be (or may include) a network server, any suitable remote server, a mainframe, a host computer, a workstation, a web server, an application server, a personal computer, a laptop, a mobile telephone (such as a Smartphone), an electronic notebook, a tablet (such as an IPAD), a personal digital assistant, a file server, any other computing or processing device, or any combination of the preceding. The functions of third party system 320 may be performed by any suitable combination of one or more servers or other components at one or more locations. In an example where the third party system 320 is a server, the server may be a private server, and the server may be a virtual or physical server. The server may include one or more servers at the same or remote locations. Also, the third party system 320 may be (or may include) any suitable component that functions as a server. In the illustrated example, the third party system 320 is one or more servers.

The third party system 320 may provide third party services to any of the components of the vending machine system 10. Also, the third party system 320 may provide any type of third party service. For example, the third party system 320 may be an example of a third party analyzer (discussed above with regard to FIGS. 1-2) that may analyze images sent to it by the vending machine 14 to determine whether there is a match between the images. In such an example, the third party system 320 may analyze the images (e.g., via biometric facial recognition, OCR, any other method), and transmit results of the analysis to the vending machine 14. The vending machine 14 may then use these results to make one or more determinations discussed in method 200 of FIG. 2.

Modifications, additions, omissions, and/or substitutions may be made to vending machine system 10 of FIG. 3, the components of the vending machine system 10 of FIG. 3, and/or the functions of the vending machine system 10 of FIG. 3 without departing from the scope of the specification. For example, the vending machine system 10 may include any number of its components (e.g., any number of client devices 312, administrator devices 316, etc.). Also, any suitable logic may perform the functions of system 10 and the components and/or devices within system 10. Furthermore, one or more components of system 10 may be separated, combined, and/or eliminated. For example, the vending machine system 10 may not include the third party systems 320.

This specification has been written with reference to various non-limiting and non-exhaustive examples. However, it will be recognized by persons having ordinary skill in the art that various substitutions, modifications, or combinations of any of the disclosed examples (or portions thereof) may be made within the scope of this specification. Thus, it is contemplated and understood that this specification supports additional examples not expressly set forth in this specification. Such examples may be obtained, for example, by combining, modifying, or reorganizing any of the disclosed steps, components, elements, features, aspects, characteristics, limitations, and the like, of the various non-limiting and non-exhaustive examples described in this specification. In this manner, Applicant reserves the right to amend the claims during prosecution to add features as variously described in this specification.

What is claimed is:

1. A vending machine comprising:
a device body having a front, a back, a first side, a second side, a top, and a bottom;
an internal space positioned within the device body, the internal space being configured to hold a plurality of age restricted products, wherein the plurality of age restricted products comprise alcohol-based products and/or cannabis-based products;
one or more dispensers positioned within the device body and configured to selectively dispense one or more of the plurality of age restricted products from the internal space to a location in or on the device body that is accessible to a user, wherein the one or more dispensers comprises one or more elevators;
a touch screen display unit coupled to the front of the device body, the touch screen display unit configured to receive a selection from the user of a pre-order that includes a selection of at least one of the plurality of age restricted products;
a camera coupled to the front of the device body, the camera configured to record an image of the user;
an identification object scanner coupled to the front of the device body, the identification scanner configured to scan an identification object provided by the user;
a second display unit coupled to the first side of the device body;
a third display unit coupled to the second side of the device body;
one or more memory units comprising one or more instructions;
one or more processors coupled to the one or more memory units and configured, upon executing the one or more instructions, to:
cause the second display unit and the third display unit to display one or more advertisements;
receive an indication of the pre-order that includes the selected age restricted product, wherein the pre-order is associated with a user profile of the user, wherein the user profile was previously set up based on a determination that the user was a match for the identification object provided by user during the previous set up process, wherein the user was determined to be the match for the identification object provided by user during the previous set up process based on a first image of the user and a first image of the identification object provided by the user during the previous set up process;
receive, from the identification object scanner, two images associated with the scanned identification object;
determine, based on a stored library of example identification objects, which of the two images associated with the scanned identification object is a front side of the scanned identification object, the front side including an image of a face;
receive, from the camera, the recorded image of the user;
identify a face in the recorded image that is closest to the camera, wherein the identification is based on a measurement in-between a set of eyes of the face;
crop the recorded image around the identified face;
based on the determined image of the front side of the scanned identification object, determine whether an identifier associated with the pre-order matches an identifier included on the determined image of the front side of the scanned identification object;
based on the determined image of the front side of the scanned identification object and further based on the cropped recorded image, determine whether the user is a match for the identification object provided by the user to the identification object scanner, wherein the user is determined to be a match for the identification object when a comparison of the cropped recorded image with the image of the face included on the determined image of the front side of the scanned identification object results in a confidence score of at least 60 percent;
based on the determined image of the front side of the scanned identification object, determine whether the user has an age that satisfies an age requirement for the selected age restricted product;
following the determination that the identifier associated with the pre-order matches the identifier included on the determined image of the front side of the scanned identification object, and further following the determination that the user is the match for the identification object provided by the user, and further following the determination that the user has the age that satisfies the age requirement for the selected age restricted product, cause at least one of the one or more dispensers to dispense the selected age restricted product from the internal space to the location in or on the device body that is accessible to the user.

2. A vending machine comprising:
a device body having a front, a back, a first side, a second side, a top, and a bottom;
an internal space positioned within the device body, the internal space being configured to hold a plurality of age restricted products;
one or more dispensers positioned within the device body and configured to selectively dispense one or more of the plurality of age restricted products from the internal space to a location in or on the device body that is accessible to a user;
a touch screen display unit coupled to the front of the device body, the touch screen display unit configured to receive a selection from the user of at least one of the plurality of age restricted products;
a camera coupled to the front of the device body, the camera configured to record an image of the user;
an identification object scanner coupled to the front of the device body, the identification scanner configured to scan an identification object provided by the user;
one or more memory units comprising one or more instructions; and
one or more processors coupled to the one or more memory units and configured, upon executing the one or more instructions, to:
receive, from the touchscreen display unit, an indication of the selected age restricted product;
receive, from the identification object scanner, two images associated with the scanned identification object;
determine which of the two images is a front side of the scanned identification object, the front side including an image of a face;
receive, from the camera, the recorded image of the user;
identify a face in the recorded image that is closest to the camera, wherein the identification is based on a measurement in-between a set of eyes of the face;
crop the recorded image around the identified face;
based on the determined image of the front side of the scanned identification object and further based on the cropped recorded image, determine whether the user is a match for the identification object provided by the user;
based on the determined image of the front side of the scanned identification object, determine whether the user has an age that satisfies an age requirement for the selected age restricted product;
following the determination that the user is the match for the identification object provided by the user and further following the determination that the user has the age that satisfies the age requirement for the selected age restricted product, cause at least one of the one or more dispensers to dispense the selected age restricted product from the internal space to the location in or on the device body that is accessible to the user.

3. The system of claim 2, wherein the plurality of age restricted products comprise nicotine-based products, alcohol-based products, and/or cannabis-based products.

4. The system of claim 2, wherein the one or more processors are further configured, upon executing the one or more instructions, to receive an indication of a pre-order for the selected age restricted product;
wherein, to receive the selection from the user of the selected age restricted product, the touch screen display unit is further configured to receive a selection from the user of the pre-order.

5. The system of claim 4, wherein the one or more processors are further configured, upon executing the one or more instructions, to determine whether an identifier associated with the pre-order matches an identifier included on the determined image of the front side of the scanned identification object;
wherein, to cause the at least one of the one or more dispensers to dispense the selected age restricted product from the internal space to the location in or on the device body that is accessible to the user, the one or more processors are further configured, upon executing the one or more instructions, to cause the at least one of the one or more dispensers to dispense the selected age restricted product from the internal space to the location in or on the device body that is accessible to the user, following the determination that the identifier associated with the pre-order matches the identifier included on the determined image of the front side of the scanned identification object.

6. The system of claim 2, wherein the one or more dispensers comprises one or more elevators.

7. The system of claim 6, wherein the one or more dispensers further comprises one or more horizontal dispensers.

8. The system of claim 2, further comprising a second display unit coupled to the first side of the device body, and a third display unit coupled to the second side of the device body;
wherein the one or more processors are further configured, upon executing the one or more instructions, to cause the second display unit and the third display unit to display one or more advertisements.

9. The system of claim 2, wherein the user is determined to be a match for the identification object when a comparison of the cropped recorded image with the image of the face included on the determined image of the front side of the scanned identification object results in a confidence score of at least 60 percent.

10. The system of claim 2, wherein the user is determined to be a match for the identification object when a comparison of the cropped recorded image with the image of the face included on the determined image of the front side of the scanned identification object results in a confidence score of 50 to 100 percent.

11. The system of claim 2, wherein, to determine whether the user is the match for the identification object provided by the user, the one or more processors are further configured, upon executing the one or more instructions, to:
transmit both the determined image of the front side of the scanned identification object and the cropped recorded image to a third party analyzer;
receive one or more results from the third party analyzer; and
utilize the received results to determine whether the user is the match for the identification object provided by the user.

12. The system of claim 11, wherein to determine whether the user has the age that satisfies the age requirement for the selected age restricted product, the one or more processors are further configured, upon executing the one or more instructions, to further utilize the received results to determine whether the user has the age that satisfies the age requirement for the selected age restricted product.

13. The system of claim 2, further comprising an iris scanner coupled to the front of the device body and configured to scan one or more of the irises of the user.

14. The system of claim 2, further comprising a credit card reader coupled to the front of the device body.

2. tem of claim 2, wherein the identification object comprises a driver's license.

16. A method comprising:
receiving, by one or processors of a vending machine from a touchscreen display unit of the vending machine, an indication of a selection by a user of at least one of a plurality of age restricted products held in the vending machine;
receiving, by the one or processors of the vending machine from an identification object scanner of the vending machine, two images associated with a scanned identification object;
determining, by the one or processors of the vending machine, which of the two images is a front side of the scanned identification object, the front side including an image of a face;
receiving, by the one or processors of the vending machine and from a camera of the vending machine, a recorded image of the user;
identifying, by the one or processors of the vending machine, a face in the recorded image that is closest to the camera, wherein the identification is based on a measurement in-between a set of eyes of the face;
cropping, by the one or processors of the vending machine, the recorded image around the identified face;
based on the determined image of the front side of the scanned identification object and further based on the cropped recorded image, determining, by the one or processors of the vending machine, whether the user is a match for the identification object provided by the user;
based on the determined image of the front side of the scanned identification object, determining, by the one or processors of the vending machine, whether the user has an age that satisfies an age requirement for the selected age restricted product; and
following the determination that the user is the match for the identification object provided by the user and further following the determination that the user has the age that satisfies the age requirement for the selected age restricted product, causing, by the one or processors of the vending machine, at least one of one or more dispensers of the vending machine to dispense the selected age restricted product from an internal space of the vending machine to the location in or on a device body of the vending machine that is accessible to the user.

17. The method of claim 16, wherein the plurality of age restricted products comprise nicotine-based products, alcohol-based products, and/or cannabis-based products.

18. The method of claim 16, wherein determining whether the user is the match for the identification object provided by the user comprises:
transmitting, by the one or processors of the vending machine, both the determined image of the front side of the scanned identification object and the cropped recorded image to a third party analyzer;
receiving, by the one or processors of the vending machine, one or more results from the third party analyzer; and
utilizing, by the one or processors of the vending machine, the received results to determine whether the user is the match for the identification object provided by the user.

19. The method of claim 18, wherein determining whether the user has the age that satisfies the age requirement for the selected age restricted product comprises further utilizing, by the one or processors of the vending machine, the received results to determine whether the user has the age that satisfies the age requirement for the selected age restricted product.

20. The method of claim 16, wherein the identification object comprises a driver's license.
